(19) United States
(12) Patent Application Publication
(10) Pub. No.: US 2022/0298352 A1
(43) Pub. Date: Sep. 22, 2022

(54) SILICONE COMPOSITION AND METHOD FOR MANUFACTURING COMPOSITE MOLDINGS

(71) Applicant: WACKER CHEMIE AG, Munich (DE)

(72) Inventors: Arvid KUHN, Burghausen (DE); Inge SCHREIBER, Julbach (DE); Michael STEPP, Überackern (AT)

(21) Appl. No.: 17/636,800

(22) PCT Filed: Aug. 19, 2019
(86) PCT No.: PCT/EP2019/072101

§ 371 Date: Feb. 18, 2022

(51) Int. Cl. C08L 83/04; C08G 77/12; C08G 77/20; C09D 183/04

(52) U.S. Cl. CPC C08L 83/04; C08G 77/12; C08G 77/20; C09D 183/04

(57) ABSTRACT

A silicone composition, a method for coating a substrate and a process for producing a composite molding.

The present invention relates to a silicone composition and a method for producing composite material such as two-component moldings made up of soft addition-crosslinking silicone elastomers in combination with hard thermoplastics such as polyamide, polycarbonate and polybutylene terephthalate.

Composite articles made of various materials are important engineering materials. A requirement which these materials have to meet is a firm bond between the individual substrate materials which is durable under the appropriate use conditions. If the silicone composition comes into contact with a mold during processing, e.g. in the processing of thermoplastic and silicone in two-component injection molding, adhesion of the silicone or of the composite to the mold is also undesirable.

Possible substrate materials are, for example, metals, glasses, ceramics, organic polymers or biological materials and also silicones or crosslinkable silicone compositions. However, in the case of silicones, a durable bond to other substrates is difficult because of the non-stick properties of silicones.

EP0961811B1 describes storage-stable addition-crosslinking silicone compositions and the use thereof as hydrophilic impression materials on the human body, for example for dental impression materials. In this application, the non-stick nature of the silicone compositions is thus advantageous since poor and thus reversible adhesion to surfaces, for example tooth enamel, and dental polymers, metals and ceramics is explicitly required.

Numerous technologies for obtaining a firm and durable bond between silicones and other substrate materials are known from the literature.

It is in principle possible to modify the chemical and physical nature of the substrate material in order to improve adhesion between the silicone and the substrate material.

An illustrative method is pretreatment of the surface of the substrate materials using UV irradiation, flame treatment, corona or plasma treatment. In such pretreatment steps, the surface or layer close to the surface of the substrate materials is activated, i.e. functional, predominantly polar groups are created which allow formation of a bond and in this way contribute to realization of a durable composite material.

Another way of producing durably strong silicone composite materials is application of primers to the substrate material. However, such primers often contain solvents in addition to adhesion-promoting additives, and these solvents have to be removed again after application to the substrate material.

A disadvantage of all of these methods is that an additional process step is required as a result of the pretreatment of the substrates. This disadvantage can be circumvented by suitable functional groups which make a contribution to adhesion in the production of the composite article being provided in the bulk or at the surface of the silicone or of the substrate material.

However, the procedure just described requires structural modification of at least one of the substrates, as a result of which the physical and chemical properties can be adversely affected. In addition, a chemical modification of polymers is associated with sometimes considerable difficulties.

Another way of achieving adhesion between a silicone and a polymeric substrate is the addition of specific additives and/or specific crosslinkers, known as bonding agents. These additives which are mixed with the uncrosslinked silicone compositions bring about adhesion to a substrate material during or after vulcanization, sometimes only after storage.

As a result, the chemical nature of the materials participating in the composite is not critically affected. In addition, a further pretreatment of the substrate materials is generally not necessary.

For example, DE102007044789 describes self-adhesive addition-crosslinking silicone compositions which display very good adhesion to engineering plastics, in particular bisphenol A-based plastics. Here, a mixture of cyclic organohydrogensiloxanes and a compound having at least two phenyl units and one alkenyl unit is used as bonding agent.

EP2603562B1, too, describes self-adhesive addition-crosslinking silicone compositions which contain a mixture of cyclic organohydrogensiloxane and an organic compound having at least two aliphatic unsaturated groups per molecule as bonding agent. According to the teaching of EP2603562B1, this combination leads to particularly good adhesion, in particular to bisphenol A-containing thermoplastics.

Many self-adhesive crosslinkable silicone compositions are known from the prior art. However, the known solutions indicate that good adhesion to particular substrates is greatly dependent on the bonding agent used. A further problem is the fact that the majority of the adhesion-promoting additives described, which are added to the silicone compositions, contain phenylsilyl or alkoxysilyl groups and these or their hydrolysis products are thus toxic and hazardous to health. This limits the use thereof to industrial materials. These materials are unsuitable for medical, cosmetic or food-related uses.

One subject of the present invention is therefore the provision of silicone compositions which are used in methods for coating substrate surfaces or for producing composite moldings and display a specific good adhesion to the substrate but at the same time do not build up troublesome adhesion to the processing apparatus, for example the injection molding tools, so that the molded articles can easily be removed from the mold and do not suffer any damage in the process, and a high process reliability is thus achieved.

The invention accordingly provides addition-crosslinking silicone rubber compositions containing
(A) at least one organopolysiloxane having at least two aliphatic double bonds in the molecule,
(B) at least one organopolysiloxane having at least three Si—H groups in the molecule, characterized in that the Si—H content thereof is at least 0.45% by weight and not more than 1.3% by weight,
(C) at least one hydrosilylation catalyst,
(D) at least one bonding agent of the general formula (I)

[H₂C═CH-(A¹)_{z}-(A²)ₘ-X]ₙB (I)
where
A¹ is a divalent C₁-C₁₈-hydrocarbon radical which is unsubstituted or substituted by halogen atoms,
A² is a divalent C₁-C₂₄-hydrocarbon radical which is interrupted by nonadjacent oxygen atoms or nitrogen atoms or groups of the formulae —NR—, —CO— or —CO—NR¹— or uninterrupted and is additionally unsubstituted or substituted by halogen atoms, with the proviso that at least 5 carbon atoms are present per oxygen or nitrogen atom,
X is a divalent group —O—, —CO— or —COO—,
B is polar radicals comprising carbon atoms and at least 2 nonadjacent oxygen atoms, where the oxygen atoms are present as ether oxygen or in hydroxyl groups, C₁-C₄-acyl groups or C₁-C₃-trialkylsilyl groups, with the proviso that not more than 3 carbon atoms are present per oxygen atom,
m is 0 or 1, preferably 0,
n is 2,
z is 0 or 1,
R and R¹ are each a monovalent C₁-C₁₀-hydrocarbon radical which is unsubstituted or substituted by halogen atoms,
with the proviso that the radicals [H₂C═CH-(A¹)_{z}-(A²)ₘ-X] are identical or different, and
(E) NO cyclic organohydrogenpolysiloxane of the general formula (III),

(SiHR⁷O)_{g}(SiR⁸R⁹O)ₖ (III),
where
R⁷ is hydrogen or is the same as R⁸, and
R⁸ and R⁹ are each, independently of one another,
   (a) a monovalent aliphatically saturated hydrocarbon radical having from 1 to 20 carbon atoms,
   or
   (b) a halogen-substituted or unsubstituted monovalent hydrocarbon radical which has from 6 to 20 carbon atoms and contains at least one aromatic 06 ring,
      or
   (c) a monovalent cycloaliphatic halogen-substituted or unsubstituted hydrocarbon radical having from 3 to 20 carbon atoms,
      or
   (d) a halogen-substituted, saturated, monovalent hydrocarbon radical which has from 2 to 20 carbon atoms and may or may not contain O or N atoms,
      or
   (e) a linear, cyclic or branched radical which contains Si atoms and is with or without one or more Si-bonded hydrogen atoms,
   g is greater than or equal to 1, and
   k is zero or a positive integer, preferably 0, 1, 2 and
   particularly preferably 0,
   with the proviso that the sum of g and k is greater than or equal to 4.

In order not to make the number of pages in the description of the present invention excessively high, only the preferred embodiments of the individual features are indicated for each component.

A reader skilled in the art should explicitly interpret this type of disclosure as implying that every combination of different degrees of preference is thus explicitly disclosed and explicitly desirable; i.e. any combination both within a single component and also between different components.

The constituent (A) has been known for a long time to those skilled in the art. Preference is given to organopolysiloxanes having at least two aliphatic double bonds in the molecule. These preferably encompass organopolysiloxane which has SiC-bonded C₁-C₆-alkyl radicals, in particular methyl radicals and/or phenyl radicals, and has at least 2 C₁-C₆-alkenyl radicals, which contain the aliphatic double bonds, per molecule. The preferred alkenyl radicals are vinyl radicals and allyl radicals. A molecule preferably contains not more than 10 alkenyl radicals.

The organopolysiloxanes (A) are preferably linear. The viscosity of (A) is guided by the desired viscosity of the formulated silicone composition or the mechanical profile of the moldings which can be produced therewith and is preferably from 200 to 200 000 mPa·s at 20° C.

In the absence of optional components, the amounts of (A) in the silicone composition of the invention are typically from 50 to 80% by weight, preferably from 60 to 70% by weight. In the presence of optional components, the amount of (A) decreases correspondingly.

The constituent (B) has likewise been known for a long time to those skilled in the art. It encompasses organopolysiloxanes having at least three Si—H groups in the molecule, preferably organopolysiloxanes which have not only Si—H groups but also SiC-bonded C1-C6-alkyl radicals, in particular methyl radicals and/or phenyl radicals.

The organopolysiloxanes (B) are preferably linear.

It is important that the Si-H content of (B) is at least 0.45% by weight and not more than 1.3% by weight, preferably at least 0.7% by weight and preferably not more than 1.2% by weight.

The viscosity of the organopolysiloxanes (B) at 20° C. is preferably from 5 to 50 000 mPa·s, in particular from 10 to 5000 mPa·s, particularly preferably from 15-100 mPa·s.

Preferred embodiments of the organopolysiloxanes (B) are, for example,

copolymers containing H(CH₃)SiO_{2/2} and (CH₃)₂SiO_{2/2} units having (CH₃)₃SiO_{1/2} end groups,

copolymers containing H(CH₃)SiO_{2/2} and (CH₃)2SiO_{2/2} units having H(CH₃)₂SiO_{1/2} end groups,

copolymers containing (Ph)₂SiO_{2/2} and H(CH₃)SiO_{2/2} units having (CH₃)₃SiO_{1/2} end groups,

copolymers containing (Ph)₂SiO_{2/2}, (CH₃)₂SiO_{2/2} and H(CH₃)Si_{2/2} units having (CH₃)₃SiO_{1/2} end groups,

copolymers containing (Ph)SiO_{3/2}, (CH₃)₂SiO_{2/2} and H(CH₃)Si_{2/2} units having (CH₃)₃SiO_{1/2} end groups,

copolymers containing (Ph)(CH₃)SiO_{2/2}, (CH₃)₂SiO_{2/2} and H(CH₃)Si_{2/2} units having (CH₃)₃SiO_{1/2} end groups,

copolymers containing (Ph)(CH₃)SiO_{2/2}, (CH₃)₂SiO_{2/2} and H(CH₃)Si_{2/2} units having H(CH₃)₂SiO_{1/2} end groups,

copolymers containing (Ph)(CH₃)SiO_{2/2} and H(CH₃)Si_{2/2} units having (CH₃)₃SiO_{1/2} end groups,

copolymers containing —Si(CH₃)₂—C₆H₄—Si(CH₃)₂O_{2/2}—, (CH₃)₂SiO_{2/2} and H(CH₃)HSiO_{1/2} units, and

copolymers containing —Si(CH₃)₂—C₆H₄—Si(CH₃)₂O_{2/2}— and (CH₃)HSiO_{2/2} units.

Particularly preferred embodiments of the organopolysiloxanes (B) are, for example, copolymers containing H(CH₃)SiO_{2/2} and (CH₃)₂SiO_{2/2} units having (CH₃)₃SiO_{1/2} end groups, and

copolymers containing (Ph)SiO_{3/2}, (CH₃)₂SiO_{2/2} and H(CH₃)Si_{2/2} units having (CH₃)3SiO_{1/2} end groups.

The amounts of (B) in the silicone composition of the invention are typically from 0.1 to 10% by weight, preferably at least 0.3% by weight and particularly preferably at least 0.5% by weight, and preferably not more than 5% by weight and particularly preferably not more than 3% by weight.

The ratio of SiH from component (B) to the total number of Si-vinyl-bonded groups in the addition-crosslinking silicone rubber composition is preferably in the range from 0.5 to 5 and particularly preferably from 0.6 to 1.8.

Constituents (C) have likewise been known for a long time to those skilled in the art. They are noble metal catalysts, in particular metals and compounds thereof from the group consisting of platinum, rhodium, palladium, ruthenium and iridium, in particular platinum and/or compounds thereof. It is possible here to use all catalysts which have also been used hitherto for the addition of Si-H groups onto aliphatically unsaturated compounds. Examples of such catalysts are metallic and finely divided platinum, which may be present on supports such as silicon dioxide, aluminum oxide or activated carbon, compounds or complexes of platinum, for example platinum halides, e.g. PtCl₄, H₂PtCl₆.6H₂O, Na₂PtCl₄.4H₂O, platinum-olefin complexes, platinum-alcohol complexes, platinum-alkoxide complexes, platinum-ether complexes, platinum-aldehyde complexes, platinum-ketone complexes, including reaction products of H₂PtCl₆.6H₂O and cyclohexanone, platinum-siloxane complexes such as platinum-vinylsiloxane complexes, in particular platinum-divinyltetramethyldisiloxane complexes with or without a content of detectable inorganically bound halogen, bis(gamma-picoline)platinum dichloride, trimethylenedipyridineplatinum dichloride, dicyclopentadieneplatinum dichloride, (dimethyl sulfoxide) diethyleneplatinum (II)dichloride and also reaction products of platinum tetrachloride with olefin and primary amine or secondary amine or primary and secondary amine, for example the reaction product of platinum tetrachloride dissolved in 1-octene with sec-butylamine, or ammonium-platinum complexes. UV-activatable hydrosilylation catalysts can also be used.

The hydrosilylation catalyst (C) can be used in any form, for example in the form of microcapsules containing hydrosilylation catalyst, or polyorganosiloxane particles. The content of hydrosilylation catalysts (C) is preferably selected so that the addition-crosslinking composition of the invention has a Pt content of from 0.1 to 200 ppm by weight, in particular from 0.5 to 40 ppm by weight.

The constituent (D) is a bonding agent of the general formula (I)

[H₂C═CH-(A¹)_{z}-(A²)ₘ-X]ₙB (I)
where
A¹ is a divalent C₁-C₁₈-hydrocarbon radical which is unsubstituted or substituted by halogen atoms,
A² is a divalent C₁-C₂₄-hydrocarbon radical which is interrupted by nonadjacent oxygen atoms or nitrogen atoms or groups of the formulae —NR—, —CO— or —CO—NR¹— or is not interrupted and is additionally unsubstituted or substituted by halogen atoms, with the proviso that at least 5 carbon atoms are present per oxygen or nitrogen atom,
X is a divalent group —O—, —CO— or —COO—,
B is polar radicals comprising carbon atoms and at least 2 nonadjacent oxygen atoms, where the oxygen atoms are present as ether oxygen or in hydroxyl groups, C₁-C₄-acyl groups or C₁-C₃-trialkylsilyl groups, with the proviso that not more than 3 carbon atoms are present per oxygen atom,
m is 0 or 1,
n is 2,
z is 0 or 1,
R and R¹ are each a monovalent C₁-C₁₀-hydrocarbon radical which is unsubstituted or substituted by halogen atoms,
with the proviso that the radicals [H₂C═CH-(A¹)_{z}-(A²)ₘ-X] are identical or different.

The bonding agents (D) are partly commercially available and are produced by generally customary methods of synthetic organic chemistry.

The divalent C₁-C₁₈-hydrocarbon radical A¹ can be saturated, aliphatically unsaturated, aromatic, linear or branched. A¹ preferably has from 3 to 13 carbon atoms.

In preferred bonding agents (D), m is 0 in the formula (I), so that A² is not present.

The two groups X present in the molecule (I) can be the following groups: twice —O—; once —O— and once —COO—; once

—COO— and once —CO—; twice —CO—; twice —COO—. Viewed chemically, the two groups X together with the group B can thus form, for example, a diether, an ether and an ester or a diester. Preference is given to diesters.

(D) preferably has at least four, in particular at least six, oxygen atoms.

Preferred bonding agents (D) are:

diesters of the following glycols, e.g. oligoalkylene glycols or polyalkylene glycols, with the following organic acids.

Glycols:
oligoethylene or polyethylene glycol
oligoethylene or polypropylene glycol
copolymers of ethylene glycol/propylene glycol
copolymers of ethylene glycol/isopropylene glycol
oligoisopropylene or polyisopropylene glycol

Particular preference is given to the diesters of oligoethylene or polyethylene glycols. Here, the oligoethylene or polyethylene glycols can consist essentially of a pure substance, i.e. have a defined number of repeating units, or the oligoethylene or polyethylene glycols can have a molecular weight distribution, i.e. be a mixture of substances having different molecular weight distributions, as can be detected by gel permeation chromatography.

Organic acids which bear at least one terminal double bond, for example:
acrylic acid
3-butenoic acid
4-pentenoic acid
5-hexanoic acid
6-heptenoic acid
7-octenoic acid
8-nonenoic acid
9-decenoic acid
10-undecenoic acid
11-dodecenoic acid
12-tridecenoic acid
13-tetradecenoic acid
14-pentadecenoic acid
15-hexadecenoic acid
and so forth.

Multiply unsaturated and/or branched carboxylic acids are also possible. However, preference is given to ones in which at least one double bond is in a terminal position.

Further preferred bonding agents are monoesters of the following glycols, e.g. oligoalkylene or polyalkylene glycols, which are etherified at one end with aliphatically unsaturated hydrocarbon radicals having from 2 to 16 carbon atoms, e.g. vinyl, allyl or longer radicals:
oligoethylene or polyethylene glycol monoallyl ethers
oligoethylene or polyethylene glycol monovinyl ethers
oligopropylene or polypropylene glycol monoallyl ethers
oligopropylene or polypropylene glycol monovinyl ethers
copolymers of ethylene glycol/propylene glycol monoallyl ethers
copolymers of ethylene glycol/propylene glycol monovinyl ethers
copolymers of ethylene glycol/isopropylene glycol monoallyl ethers
copolymers of ethylene glycol/isopropylene glycol monovinyl ethers
oligoisopropylene or polyisopropylene glycol monoallyl ethers
oligoisopropylene or polyisopropylene glycol monovinyl ethers
   where the monoesters are formed with the abovementioned acids.

Particularly preferred bonding agents (D) are:

diesters of oligoethylene glycol with terminally unsaturated C₆-C₁₆-carboxylic acids, in particular with 10-undecenoic acid. The oligoethylene glycol has from 2 to 40 ethylene glycol units —[CH₂—CH₂—O]—, preferably from 3 to 20 ethylene glycol units —[CH₂—CH₂—O]—, in particular 4-10 ethylene glycol units —[CH₂—CH₂—O]—.

The silicone compositions contain at least 0.05% by weight of (D), preferably at least 0.1% by weight of (D). Furthermore, they contain not more than 10% by weight of (D), preferably not more than 4% by weight of (D).

The component (E) is NOT present since the desired good adhesion to the substrate is surprisingly achieved without this component (E), with at the same time lower, i.e. reversible, adhesion to the processing apparatuses, for example the injection molding tools.

The addition-crosslinkable silicone compositions of the invention can additionally contain at least one filler (F) as further constituent. Suitable fillers are known to those skilled in the art. Nonreinforcing fillers (F) having a BET surface area of up to 50 m²/g are, for example, quartz, diatomaceous earth, talc, calcium silicate, zirconium silicate, zeolites, metal oxide powders such as aluminum, titanium, iron or zinc oxides and mixed oxides thereof, barium sulfate, calcium carbonate, gypsum, silicon nitride, silicon carbide, boron nitride, glass and polymer powders. Reinforcing fillers, i.e. fillers having a BET surface area of at least 50 m²/g, in particular from 100 to 400 m²/g, are, for example, pyrogenic silica, precipitated silica, aluminum hydroxide, carbon black such as furnace black and acetylene black and silicon-aluminum mixed oxides having a large BET surface area. The abovementioned fillers (F) can have been hydrophilized, for example by treatment with organosilanes, organosilazanes or organosiloxanes or by etherification of hydroxyl groups to form alkoxy groups. It is possible to use one type of filler (F), but it is also possible to use a mixture of at least two fillers (F). The silicone compositions of the invention preferably contain at least 3% by weight, particularly preferably at least 5% by weight, in particular at least 10% by weight, and not more than 50% by weight of filler (F).

The silicone compositions of the invention can optionally contain possible additives as further constituent (G) in a proportion of from 0 to 70% by weight, preferably from 0.0001 to 40% by weight. These additives are known to those skilled in the art and can be, for example, resin-like polyorganosiloxanes which are different from the polyorganosiloxanes (A) and (B) and naturally also (H), dispersants, solvents, bonding agents, pigments, dyes, plasticizers, organic polymers, heat stabilizers and inhibitors. Furthermore, thixotroping constituents, e.g. finely divided silica or other commercial thixotropy additives, can be present as constituent.

In addition, further additives which serve to set the processing time, initiation temperature and crosslinking rate of the crosslinking compositions in a targeted manner can be present. These inhibitors and stabilizers are well known in the field of crosslinking compositions.

The silicone compositions of the invention can optionally contain, as further constituent (H), organopolysiloxanes which have at least two SiH groups in the molecule and are different from the component (B). These are preferably mostly linear organopolysiloxanes which have SiC-bonded C₁-C₆-alkyl radicals, in particular methyl radicals and/or phenyl radicals, in addition to Si—H groups. The organopolysiloxanes (H) preferably have terminal SiH groups. As in the case of the constituent (A), the viscosity of the organopolysiloxanes (H) is guided by the desired viscosity of the formulated silicone composition and the mechanical profile of the vulcanizates produced therefrom and is 10-200 000 mPa·s, preferably 15-10 000 m·Pas at 20° C.

Examples of organopolysiloxanes (H) are dimethylsiloxy-terminated polydimethylsiloxanes and dimethylsiloxy-terminated copolymers of dimethylsiloxy units and methylphenylsiloxy units.

The amounts of constituent (H) in the silicone composition of the invention are typically 0-50% by weight, preferably 0-25% by weight.

Overall, the amounts of all constituents are always selected so that they always add up to 100% by weight in the silicone compositions of the invention.

The present invention further provides a method for producing the addition-crosslinkable silicone composition of the invention. The production or compounding of the silicone composition of the invention is preferably carried out by mixing the components (A) to (D), with or without (F) and/or (G) and/or (H). The composition of the invention can be produced as 1-component, 2-component or multicomponent composition. Crosslinking is effected, depending on the catalyst, by heating or irradiation with a suitable light source.

The present invention further provides a method for coating substrate surfaces and for producing composite moldings, where

a) the substrate surfaces are coated with a silicone rubber composition or/and the substrates and/or substrate combinations are assembled and the silicone rubber composition is introduced into the intermediate spaces,

b) the silicone rubber composition then cures,

c) a demolding operation then follows,

characterized in that the silicone rubber composition

is an addition-crosslinking silicone rubber composition containing
(A) at least one organopolysiloxane having at least two aliphatic double bonds in the molecule,
(B) at least one organopolysiloxane having at least three Si—H groups in the molecule, characterized in that the Si—H content thereof is at least 0.45% by weight and not more than 1.3% by weight,
(C) at least one hydrosilylation catalyst,
(D) at least one bonding agent of the general formula (I)

[H₂C═CH-(A¹)_{z}-(A²)ₘ-X]ₙB (I)
where
A¹ is a divalent C₁-C₁₈-hydrocarbon radical which is unsubstituted or substituted by halogen atoms,
A² is a divalent C₁-C₂₄-hydrocarbon radical which is interrupted by nonadjacent oxygen atoms or nitrogen atoms or groups of the formulae —NR—, —CO— or —CO—NR¹— or uninterrupted and is additionally unsubstituted or substituted by halogen atoms, with the proviso that at least 5 carbon atoms are present per oxygen or nitrogen atom,
X is a divalent group —O—, —CO—or —COO—,
B is polar radicals comprising carbon atoms and at least 2 nonadjacent oxygen atoms, where the oxygen atoms are present as ether oxygen or in hydroxyl groups, C₁-C₄-acyl groups or C₁-C₃-trialkylsilyl groups, with the proviso that not more than 3 carbon atoms are present per oxygen atom,
m is 0 or 1 (preferably 0)
n is 2,
z is 0 or 1,
R and R¹ are each a monovalent C₁-C₁₀-hydrocarbon radical which is unsubstituted or substituted by halogen atoms,
with the proviso that the radicals [H₂C═CH-(A¹)_{z}-(A²)ₘ-X] are identical or different,
(E) NO cyclic organohydrogenpolysiloxane of the general formula (III),

(SiHR⁷O)_{g}(SiR⁸R⁹O)ₖ (III),
where
R⁷ is hydrogen or is the same as R⁸, and
R⁸ and R⁹ are each, independently of one another,
   (a) a monovalent aliphatically saturated hydrocarbon radical having from 1 to 20 carbon atoms,
   or
   (b) a halogen-substituted or unsubstituted monovalent hydrocarbon radical which has from 6 to 20 carbon atoms and contains at least one aromatic C₆ ring,
   or
   (c) a monovalent cycloaliphatic halogen-substituted or unsubstituted hydrocarbon radical having from 3 to 20 carbon atoms,
      or
   (d) a halogen-substituted, saturated, monovalent hydrocarbon radical which has from 2 to 20 carbon atoms and may or may not contain O or N atoms,
      or
   (e) a linear, cyclic or branched radical which contains Si atoms and is with or without one or more Si-bonded hydrogen atoms,
   g is greater than or equal to 1, and
   k is zero or a positive integer, preferably 0, 1, 2 and particularly preferably 0,
   with the proviso that the sum of g and k is greater than or equal to 4.

The substrates are thermoplastics, preferably polyamide, polycarbonate and polybutylene terephthalate, particularly preferably polycarbonate.

The present invention further provides coated substrates and composite moldings obtainable by the method of the invention.

It has surprisingly been found that only the combination of (B) having this selected Si—H content in combination with the specific bonding agents (D) leads to a synergistic effect, with firstly very good adhesion to substrates composed of hard thermoplastics such as polyamide, polycarbonate and

polybutylene terephthalate and secondly very poor adhesion to the injection molding tool made of, for example, steel. It is unexpected and contrary to the teaching of EP2190927B1 that the additional component (E) is NOT required to achieve this. In the method for coating substrate surfaces and for producing composite moldings, the compositions of the invention make a very reliable demolding operation possible, as a result of which fewer malfunctions occur and an overall high process reliability is thus achieved. This leads to improved economics of a production plant.

### EXAMPLES

The following examples describe the way in which the present invention can be carried out in principle, but without restricting the invention to the contents disclosed therein.

All percentages are by weight. Unless indicated otherwise, all manipulations are carried out at room temperature (about 20° C.) and under atmospheric pressure (about 1.013 bar). The apparatuses are commercial laboratory apparatuses as can be purchased from numerous apparatus manufacturers.

Substrate Materials

The adhesion of the silicone compositions according to the invention and silicone compositions which are not according to the invention to the following substrates was tested:
Polycarbonate: Makrolon® 2405 (Bayer MaterialScience AG)
Polybutylene terephthalate (PBT): Pocan® B 1305 (Lanxess)
V2A steel (industrial grade)

Before production of the test specimens for the separation force measurement, the substrate materials for the press vulcanization process and the thermoplastic granules for the injection molding process were dried in a suitable way in accordance with the manufacturer's instructions. For the press vulcanization process, the test specimens were additionally degreased beforehand.

Characterization of the Adhesion

The production of the test specimens for the separation force measurement was carried out firstly under laboratory conditions by the press vulcanization process. In addition, further test specimens were produced under realistic manufacturing conditions by the two-component injection molding process.

For production by press vulcanization, an appropriate stainless steel mold was used and a substrate which had preferably been produced by injection molding and had dimensions of 60×25×2 mm was laid in this and each mold was subsequently filled with the addition-crosslinking silicone composition to be tested. Vulcanization was carried out over a period of 3 minutes at a temperature of 120° C. and a pressing force of 30 metric tons for the substrate material polycarbonate, with complete crosslinking of the liquid silicone composition occurring. In the case of the substrate material V2A, vulcanization was carried out at 180° C. over a period of 5 minutes. All test specimens were subsequently cooled to room temperature. The test specimen produced in this way, consisting of substrate and 2.5 mm thick liquid silicone elastomer layer, was taken from the mold and then firstly stored for at least 16 hours at room temperature. The test specimen was subsequently clamped in a tensile testing apparatus and the maximum separation force necessary to remove the adhering silicone elastomer strip was determined.

The production of a test specimen by the 2-component injection molding process was carried out using an injection molding machine according to the prior art having a rotating plate tool. Here, a thermoplastic main element was firstly produced and was transported by means of a rotating plate to the second injection molding apparatus. In the next process step, the silicone composition was sprayed onto the finished thermoplastic main element and vulcanized onto the substrate. The injection pressure for self-adhesive addition-crosslinking silicone compositions is usually in the range from 200 to 2000 bar, but can in particular cases be below or above these values. The injection temperature for self-adhesive addition-crosslinking silicone compositions is usually in the range from 15 to 50° C., with temperatures likewise being able to be below or above these temperatures in individual cases.

The test specimens produced by the 2-component injection molding process and employed for assessing the strength of adhesion of the silicone elastomers according to the invention to the substrates are indicated in DIN ISO 813.

Before the adhesion test, the test specimens produced by the 2-component injection molding process were likewise stored at room temperature for at least 16 hours. The adhesion test and the crack formation assessment were carried out in the same way as for the test specimens from press vulcanization.

The quantification of the adhesion of the composites consisting of silicone elastomer and thermoplastic main element was carried out by a method based on the adhesion test in accordance with DIN ISO 813. Here, the 90° peel method was carried out with the substrate and silicone elastomer strip being at an angle of 90° to one another and the pull-off speed preferably being 50 mm/min. The separation force (SF) determined was reported in N/mm as the ratio of the maximum force N and the width of the test specimen. Depending on the example, 3-5 laminates were measured and the separation force was determined as an average.

Base Composition 1

232 g of a vinyldimethylsiloxy-terminated polydimethylsiloxane having a viscosity of 20 000 mPa·s (25° C.) were placed in a commercial laboratory kneader, heated to 150° C. and admixed with 159 g of a hydrophobic pyrogenic silica having a specific surface area of 300 m²/g (measured by the BET method) and a carbon content of 3.9-4.2% by weight.

This resulted in a highly viscous composition which was subsequently diluted with 130 g of the abovementioned polydimethylsiloxane. The composition obtained was freed of water and excess loading agent residues, in particular volatile constituents, by kneading under reduced pressure (10 mbar) at 150° C. for one hour.

Base Composition 2

202 g of a vinyldimethylsiloxy-terminated polydimethylsiloxane having a viscosity of 20 000 mPa·s (25° C.), 45 g of hexamethyldisilazane and 15 g of water were placed in a commercial laboratory kneader and 150 g of a hydrophilic pyrogenic silica having a specific surface area of 300 m²/g (measured by the BET method) were added. This resulted in a highly viscous composition which was freed of water and excess loading agent residues, in particular volatile constituents, by kneading under reduced pressure (10 mbar) at 150° C. for two hours and diluted with 110 g of the abovementioned vinyl-terminated polydimethylsiloxane.

Base Composition 3

235 g of a vinyldimethylsiloxy-terminated polydimethylsiloxane having a viscosity of 20 000 mPa·s (25° C.) and 24 g of an OH-terminated polydimethylsiloxane having a viscosity of 40 mPa·s were placed in a commercial laboratory kneader. While heating at up to 150° C., 143 g of a precipitated silica having a specific surface area of 200 m²/g (measured by the BET method) were added. This resulted in a highly viscous composition which was subsequently diluted with 90 g of the abovementioned vinyl-terminated polydimethylsiloxane. The composition obtained was freed of volatile constituents by kneading under reduced pressure (10 mbar) at 150° C. for one hour.

A-Component 1

345.8 g of base composition 1 were mixed with 3.5 g of a dimethylvinylsiloxy-terminated polydimethylsiloxane having methylvinylsiloxy groups and a vinyl content of 2.5 mmol/g and a viscosity of 340 mPa·s and 0.7 g of a catalyst solution which contained a platinum-divinyltetramethyldisiloxane complex in silicone polymer and had a Pt content of 1% by weight.

Crosslinker 1

Trimethylsiloxy-terminated copolymer of dimethylsiloxy and methylhydrogensiloxy units in a molar ratio of 0.4:1, having a viscosity of 35 mPa·s and an SiH content of 1.1% by weight.

Crosslinker 2

Trimethylsiloxy-terminated copolymer of dimethylsiloxy and methylhydrogensiloxy units in a molar ratio of 2:1, having a viscosity of 115 mPa·s and an SiH content of 0.5% by weight.

Crosslinker 3

Trimethylsiloxy-terminated copolymer of dimethylsiloxy, methylhydrogensiloxy and phenylsiloxy units in a molar ratio of 0.33:1:0.18, having a viscosity of 80 mPa·s and an SiH content of 0.9% by weight.

Crosslinker 4

Trimethylsiloxy-terminated copolymer of dimethylsiloxy, methylhydrogensiloxy and phenylsiloxy units in a molar ratio of 0.36:1:0.12, having a viscosity of 18 mPa·s and an SiH content of 0.9% by weight.

Crosslinker 5

Trimethylsiloxy-terminated copolymer of dimethylsiloxy and methylhydrogensiloxy units in a molar ratio of 9:1, having a viscosity of 150 mPa·s and an SiH content of 0.14% by weight.

Crosslinker 6

Trimethylsiloxy-terminated polymethylhydrogensiloxane, having a viscosity of 25 mPa·s and an SiH content of 1.6% by weight.

Bonding Agent 1

42.5 g of polyethylene glycol 200 (obtainable from Merck) were added to 85.0 g of 10-undecenoic acid chloride (obtainable from Merck) over a period of 30 min at 80° C. while stirring, and stirring was continued until gas evolution was no longer discernible. After addition of 1.7 g of hexamethyldisilazane, the mixture was heated for one hour at 80° C. under reduced pressure (<4 mbar). After cooling, the residue was filtered through Dicalite filter aid. 94 g of a clear, yellow-orange-colored liquid were obtained. The ¹H-NMR spectrum corresponded to the bis-10-undecenoic ester of polyethylene glycol 200.

Bonding Agent 2

204.9 g of polyethylene glycol 300 (obtainable from Merck) were placed in a flask at 80° C. and 208.0 g of undecenoic acid chloride (obtainable from Merck) were added over a period of 45 minutes. After the addition was complete, the mixture was stirred at 80° C. for 30 minutes. 13.7 g of hexamethyldisilazane were then added at 80° C. and the mixture was stirred for a further 5 minutes. The reaction mixture was heated for one hour at 120° C. and 1 mbar. The residue was cooled to room temperature and filtered through Dicalite filter aid. 360.9 g of a clear, yellow liquid were obtained. The ¹H-NMR spectrum corresponded to that of the bis-10-undecenoic ester of polyethylene glycol 300.

The A- and B-components from the examples are, for example, intensively mixed in a Speedmixer (from Hauschild) and the mixture was applied to the substrates in the mold.

Separation force values of >10 N/mm to polycarbonate for test specimens produced as described above in a pressing mold are considered to be good.

Separation force values of <2 N/mm to V2A steel for test specimens produced as described above in a pressing mold are considered to be sufficiently low for the corresponding formulations not to build up troublesome adhesion to the injection molding tool in an industrial injection molding process.

### Example 1 (According to the Invention)

The A-component 1 was used as A-component.

B-Component:

95 g of the base composition 2 were mixed with 0.1 g of 1-ethynyl-1-cyclohexanol, 3 g of the crosslinker 3 and 1.5 g of bonding agent 1.

| Vulcanizate: | Shore A 42 |
|---|---|
| Adhesion to Makrolon 2405 | 11.7 N/mm with cohesion crack |
| Adhesion to V2A | 1.6 N/mm with adhesion crack |

### Example 2 (According to the Invention)

The A-component 1 was used as A-component.

B-Component:

95 g of the base composition 2 were mixed with 0.1 g of 1-ethynyl-1-cyclohexanol, 3 g of the crosslinker 3 and 0.75 g of bonding agent 2.

| Vulcanizate: | Shore A 41 |
|---|---|
| Adhesion to Makrolon 2405 | 10.9 N/mm with cohesion crack |
| Adhesion to V2A | 1.2 N/mm with adhesion crack |

### Example 3 (According to the Invention)

The A-component 1 was used as A-component.

B-Component:

95 g of the base composition 2 were mixed with 0.1 g of 1-ethynyl-1-cyclohexanol, 2.7 g of the crosslinker 4 and 0.75 g of bonding agent 2.

| Vulcanizate: | Shore A 42 |
|---|---|
| Adhesion to Makrolon 2405 | 12.9 N/mm with cohesion crack |
| Adhesion to V2A | 0 N/mm with adhesion crack |

### Example 4 (According to the Invention)

The A-component 1 was used as A-component.

B-Component:

95 g of the base composition 2 were mixed with 0.1 g of 1-ethynyl-1-cyclohexanol, 3.0 g of the crosslinker 3 and 1.0 g of bonding agent 2.

| Vulcanizate: | Shore A 51 |
|---|---|
| Adhesion to Makrolon 2405 | 14.8 N/mm with cohesion crack |
| Adhesion to V2A | 0.2 N/mm with adhesion crack |

### Example 5 (According to the Invention)

The A-component 1 was used as A-component.

B-Component:

95 g of the base composition 1 were mixed with 0.1 g of 1-ethynyl-1-cyclohexanol, 2.8 g of the crosslinker 3 and 1.3 g of bonding agent 1.

| Vulcanizate: | Shore A 40 |
|---|---|
| Adhesion to Makrolon 2405 | 10.7 N/mm with cohesion crack |
| Adhesion to V2A | 1.3 N/mm with adhesion crack |

### Example 6 (According to the Invention)

The A-component 1 was used as A-component.

B-Component:

96.5 g of the base composition 3 were mixed with 0.1 g of 1-ethynyl-1-cyclohexanol, 2.7 g of the crosslinker 4 and 0.8 g of bonding agent 1.

| Vulcanizate: | Shore A 40 |
|---|---|
| Adhesion to Makrolon 2405 | 11.9 N/mm with cohesion crack |
| Adhesion to V2A | 1.6 N/mm with adhesion crack |

### Example 7 (According to the Invention)

The A-component 1 was used as A-component.

B-Component:

96.5 g of the base composition 3 were mixed with 0.1 g of 1-ethynyl-1-cyclohexanol, 2.5 g of the crosslinker 1 and 1.0 g of bonding agent 1.

| Vulcanizate: | Shore A 40 |
|---|---|
| Adhesion to Makrolon 2405 | 11.3 N/mm with cohesion crack |
| Adhesion to V2A | 1.8 N/mm with adhesion crack |

### Example 8 (According to the Invention)

The A-component 1 was used as A-component.

B-Component:

61 g of the base composition 2 were mixed with 0.02 g of 1-ethynyl-1-cyclohexanol, 25 g of a dimethylsiloxy-terminated polydimethylsiloxane having a viscosity of 950 mPas, 2.4 g of the crosslinker 4 and 0.5 g of bonding agent 1.

The A- and B-component are mixed with one another in a ratio of 1:1 in a Speedmixer, applied to the substrates and vulcanized under atmospheric pressure for 1 hour at 80° C. in a drying oven. The vulcanizate has a Shore A hardness of 28. The composite displays a cohesion crack in the silicone in the separation test.

### Example 9 (According to the Invention)

The A-component 1 was used as A-component.

B-Component:

95 g of the base composition 2 were mixed with 0.1 g of 1-ethynyl-1-cyclohexanol, 2.7 g of the crosslinker 4 and 1.0 g of bonding agent 1.

The sample was processed by the 2-component injection molding process.

| Vulcanizate: | Shore A 41 |
|---|---|
| Adhesion to Makrolon 2405 | 18.5 N/mm with cohesion crack |
| Adhesion to Pocan 1305 (PBT) | 16.2 N/mm with cohesion crack |
| No adhesion to the mold. | |

### Example 10 (According to the Invention)

The A-component 1 was used as A-component.

B-Component:

95 g of the base composition 2 were mixed with 0.1 g of 1-ethynyl-1-cyclohexanol, 2.5 g of the crosslinker 1 and 1.0 g of bonding agent 1.

The sample was processed by the 2-component injection molding process.

| Vulcanizate: | Shore A 46 |
|---|---|
| Adhesion to Makrolon 2405 | 17.0 N/mm with cohesion crack |
| Adhesion to Pocan 1305 (PBT) | 13.8 N/mm with cohesion crack |
| No adhesion to the mold. | |

### Example N.1 (Not According to the Invention)

The A-component 1 was used as A-component.

B-Component:

95 g of the base composition 2 were mixed with 0.1 g of 1-ethynyl-1-cyclohexanol, 2.3 g of the crosslinker 2, 1.50 g of a mixture of HD5/HD6 rings and 2.0 g of diallyl adipate (procured from ABCR).

| Vulcanizate: | Shore A 21 |
|---|---|
| Adhesion to Makrolon 2405 | 2.5 N/mm with adhesion crack |
| Adhesion to V2A | 2.4 N/mm with adhesion crack |

### Example N.2 (Not According to the Invention)

The A-component 1 was used as A-component.

B-Component:

95 g of the base composition 2 were mixed with 0.1 g of 1-ethynyl-1-cyclohexanol, 3.0 g of the crosslinker 3 and 1.0 g of undecenoic acid esterified with monomethoxytriethylene glycol (procured under the name u1OMEE-03 from Elevance).

| Vulcanizate: | Shore A 40 |
|---|---|
| Adhesion to Makrolon 2405 | 0 N/mm with adhesion crack |
| Adhesion to V2A | 1.9 N/mm with adhesion crack |

### Example N.3 (Not According to the Invention)

The A-component 1 was used as A-component.

B-Component:

95 g of the base composition 2 were mixed with 0.1 g of 1-ethynyl-1-cyclohexanol, 7.1 g of the crosslinker 5 and 0.75 g of bonding agent 2.

| Vulcanizate: | Shore A 38 |
|---|---|
| Adhesion to Makrolon 2405 | 3.2 N/mm with adhesion crack |
| Adhesion to V2A | 0.8 N/mm with adhesion crack |

### Example N.4 (Not According to the Invention)

The A-component 1 was used as A-component.

B-Component:

95 g of the base composition 2 were mixed with 0.1 g of 1-ethynyl-1-cyclohexanol, 0.7 g of the crosslinker 6 and 0.75 g of bonding agent 2.

| Vulcanizate: | Shore A 47 |
|---|---|
| Adhesion to Makrolon 2405 | 6.9 N/mm with mixed cracking |
| Adhesion to V2A | 4.2 N/mm with mixed cracking |

1-9. (canceled)

10. An addition-crosslinking silicone rubber composition, comprising:
(A) at least one organopolysiloxane having at least two aliphatic double bonds in the molecule;
(B) at least one organopolysiloxane having at least three Si-H groups in the molecule, wherein the Si-H content thereof is at least 0.45% by weight and not more than 1.3% by weight;
(C) at least one hydrosilylation catalyst;
(D) at least one bonding agent of the general formula (I)
[H₂C═CH-(A¹)_{z}-(A²)ₘ-X]ₙB (I)
wherein A^{l} is a divalent C₁-C₁₈-hydrocarbon radical which is unsubstituted or substituted by halogen atoms;
wherein A² is a divalent C₁-C₂₄-hydrocarbon radical which is interrupted by nonadjacent oxygen atoms or nitrogen atoms or groups of the formulae —NR—, —CO— or CO—NR¹— or uninterrupted and is additionally unsubstituted or substituted by halogen atoms, with the proviso that at least 5 carbon atoms are present per oxygen or nitrogen atom;
wherein X is a divalent group —O—, —CO— or —COO—;
wherein B is polar radicals comprising carbon atoms and at least 2 nonadjacent oxygen atoms, wherein the oxygen atoms are present as ether oxygen or in hydroxyl groups, C₁-C₄-acyl groups or C₁-C₃-trialkylsilyl groups, and wherein not more than 3 carbon atoms are present per oxygen atom;
wherein m is 0 or 1;
wherein n is 2;
wherein z is 0 or 1;
wherein R and R¹ are each a monovalent C₁-C₁₀-hydrocarbon radical which is unsubstituted or substituted by halogen atoms;
wherein the radicals [H₂C═CH-(A¹)_{z}-(A²)ₘ-X] are identical or different;
(E) NO cyclic organohydrogenpolysiloxane of the general formula (III),
(SiHR⁷O)_{g}(SiR⁸R⁹O)ₖ (III),
wherein R⁷ is hydrogen or is the same as R⁸; and
wherein R⁸ and R⁹ are each, independently of one another,
(a) a monovalent aliphatically saturated hydrocarbon radical having from 1 to 20 carbon atoms, or
(b) a halogen-substituted or unsubstituted monovalent hydrocarbon radical which has from 6 to 20 carbon atoms and contains at least one aromatic C₆ ring, or
(c) a monovalent cycloaliphatic halogen-substituted or unsubstituted hydrocarbon radical having from 3 to 20 carbon atoms, or
(d) a halogen-substituted, saturated, monovalent hydrocarbon radical which has from 2 to 20 carbon atoms and may or may not contain 0 or N atoms, or
(e) a linear, cyclic or branched radical which contains Si atoms and is with or without one or more Si-bonded hydrogen atoms,
wherein g is greater than or equal to 1;
wherein k is zero or a positive integer, preferably 0, 1, 2 and particularly preferably 0; and
wherein the sum of g and k is greater than or equal to 4.

11. The composition of claim 11, wherein m in the general formula (I) is 0.

12. The composition of claim 11, wherein the viscosity of the organopolysiloxanes (B) at 20° C. is from 5 to 50 000 mPa·s, in particular from 10 to 5000 mPa·s, particularly preferably 15-100 mPa·s.

13. The composition of claims 11, wherein (D) is a diester of oligoethylene glycol with terminally unsaturated C₆-C₁₆-carboxylic acids.

14. The composition of claim 13, wherein the carboxylic acid is 10-undecenoic acid.

15. The composition of claim 13, wherein the oligoethylene glycol has from 2 to 40 ethylene glycol units —[CH₂—CH₂—O]—, preferably from 3 to 20 ethylene glycol units —[CH₂—CH₂—O]—, in particular 4-10 ethylene glycol units —[CH₂—CH₂—O]—.

16. A method for coating substrate surfaces and for producing composite moldings, where the method comprises:
a) providing a substrate, wherein the substrate surfaces are coated with a silicone rubber composition and/or the substrates and/or substrate combinations are assembled and the silicone rubber composition is introduced into the intermediate spaces;
b) allowing the silicone rubber composition to cure;
c) a demolding operation then follows;
wherein the silicone rubber composition is an addition-crosslinking silicone rubber composition comprising
(A) at least one organopolysiloxane having at least two aliphatic double bonds in the molecule;
(B) at least one organopolysiloxane having at least three Si—H groups in the molecule, wherein the Si-H content thereof is at least 0.45% by weight and not more than 1.3% by weight;
(C) at least one hydrosilylation catalyst;
(D) at least one bonding agent of the general formula (I)
[H₂C═CH-(A¹)ₘ-(A²)ₘ-X]ₙB (I)
where A² is a divalent C₁-C₁₈-hydrocarbon radical which is unsubstituted or substituted by halogen atoms;
wherein A² is a divalent C₁-C₂₄-hydrocarbon radical which is interrupted by nonadjacent oxygen atoms or nitrogen atoms or groups of the formulae —NR—, —CO— or —CO—NR¹— or uninterrupted and is additionally unsubstituted or substituted by halogen atoms, and wherein at least 5 carbon atoms are present per oxygen or nitrogen atom;
wherein X is a divalent group —O—, —CO— or —COO—;
wherein B is polar radicals comprising carbon atoms and at least 2 nonadjacent oxygen atoms, where the oxygen atoms are present as ether oxygen or in hydroxyl groups, C₁-C₄-acyl groups or C₁-C₃-trialkylsilyl groups, with the proviso that not more than 3 carbon atoms are present per oxygen atom;
wherein m is 0 or 1 (preferably 0);
wherein n is 2;
wherein z is 0 or 1;
wherein R and R¹ are each a monovalent C₁-C₁₀-hydrocarbon radical which is unsubstituted or substituted by halogen atoms;
wherein the radicals [H₂C═CH-(A¹)_{z}-(A²)ₘ-X] are identical or different,
(E) NO cyclic organohydrogenpolysiloxane of the general formula (III),
(SiHR⁷O)_{g}(SiR⁸R⁹O)ₖ (III),
wherein R⁷ is hydrogen or is the same as R⁸; and
wherein R⁸ and R⁹ are each, independently of one another;
(a) a monovalent aliphatically saturated hydrocarbon radical having from 1 to 20 carbon atoms; or
(b) a halogen-substituted or unsubstituted monovalent hydrocarbon radical which has from 6 to 20 carbon atoms and contains at least one aromatic C₆ ring; or
(c) a monovalent cycloaliphatic halogen-substituted or unsubstituted hydrocarbon radical having from 3 to 20 carbon atoms; or
(d) a halogen-substituted, saturated, monovalent hydrocarbon radical which has from 2 to 20 carbon atoms and may or may not contain O or N atoms; or
(e) a linear, cyclic or branched radical which contains Si atoms and is with or without one or more Si-bonded hydrogen atoms;
wherein g is greater than or equal to 1;
wherein k is zero or a positive integer, preferably 0, 1, 2 and particularly preferably 0; and
wherein the sum of g and k is greater than or equal to 4.

17. The method of claim 16, wherein the thermoplastics, preferably polyamide, polycarbonate and polybutylene terephthalate, particularly preferably polycarbonate, are used as substrate.

18. The method of claim 16, wherein a coated substrate or composite molding us obtained.
